(19) United States
(12) Patent Application Publication
(10) Pub. No.: US 2026/0278495 A1
(43) Pub. Date: Sep. 17, 2026

(54) METHOD FOR ASSISTING REMOTE OPERATORS IN ORIENTING THEMSELVES TO THEIR IMMEDIATE ENVIRONMENT AND CAPTURING CRITICAL INFORMATION IN REAL-TIME

(71) Applicant: Innovative Logistics, LLC, Fort Smith, AR (US)

(72) Inventors: Ellen Uren, Fort Smith, AR (US); Darryl Jakob Berry, Fort Smith, AR (US); Hung Tien Tran, Fort Smith, AR (US); Evan Foley, Barling, AR (US); Donald Wayne Wilson, Muldrow, OK (US); Robert Cope, Paris, AR (US); Kerry Jenkins, Little Rock, AR (US); Amit Patel, Fort Smith, AR (US); James Bottjen, Fort Smith, AR (US)

(21) Appl. No.: 19/566,219

(22) Filed: Mar. 13, 2026

Related U.S. Application Data
(60) Provisional application No. 63/772,135, filed on Mar. 14, 2025.
(60) Provisional application No. 63/924,191, filed on Nov. 24, 2025.

(51) Int. Cl. G06Q 10/0631

(52) U.S. Cl. CPC G06Q 10/063112; G06Q 10/063114

(57) ABSTRACT

The teleoperations system assigns move assignments to specific vehicles instead of directly to different teleoperators. Instead of operating a specific vehicle for an entire day, the teleoperator instead selects (or is assigned) move assignments and is connected to the vehicle associated with the move assignment. The teleoperator then performs the move assignment for that particular vehicle and then selects (or is assigned) the next move assignment. The next assignment may be associated with the same vehicle or an entirely different vehicle. A drive fulfillment system provides teleoperators with real-time feedback on their current location, detailed information on materials available nearby, access to camera feeds for identifying materials in transit, and the ability to determine their location based on the vehicle's position.

### CROSS-REFERENCE TO RELATED APPLICATIONS

This application claims priority to U.S. Provisional Application Ser. No. 63/772,135, filed Mar. 14, 2025 and U.S. Provisional Application Ser. No. 63/924,191, filed Nov. 24, 2025, the entire contents of which are hereby incorporated by reference in their entireties.

### FIELD OF THE INVENTION

The present invention provides a teleoperations system for assigning teleoperators with work tasks based on a plurality of different criteria. The present invention also provides a teleoperator interface with real-time feedback on a current vehicle location, detailed information on materials available nearby, access to camera feeds for identifying materials in transit, and the ability to determine their location based on a vehicle's position.

### BACKGROUND

In traditional teleoperations, teleoperators utilize a terminal to connect to a vehicle and control its movement and operation. The teleoperator retains control over the vehicle for the workday or until another vehicle is selected. Different tasks may be assigned to the teleoperator to perform, such as moving freight in a warehouse, the teleoperator can select the order of the work tasks or the system can assign tasks to teleoperators automatically.

FIG. 1 depicts an example traditional workflow 100 for on-site operators. First, work tasks are provided to the on-site operator via an electronic device or printed instructions in step 102. The on-site operator then navigates to the origin specified in the work task in step 104. For example, if the work task relate to loading a platform or pallet, the on-site operator would navigate the vehicle to the location of the freight to be conveyed. Using the terminal, the on-site operator picks up the target freight in step 106. The status of the work task is monitored by a work control system (WCS) within the warehouse in step 108. For example, the WCS may monitor the current status or location of the vehicle as well as the target freight using one or more sensors positioned throughout the warehouse. The vehicle itself may report its position and status using onboard sensors or GPS positioning. The operator navigates to a destination in step 110 and conveys the target freight to the destination in step 112 and drops it off (e.g., onto a pallet or other platform). The WCS updates the location of the target freight and verifies that the work task has been completed in step 114. The on-site operator is then free to perform the next work task in step 116.

The traditional workflow 100 is similar to teleoperations, with the main difference being that the teleoperator controls the vehicle remotely other than directly in the warehouse. Otherwise, the workflow 100 depicted in FIG. 1 is similar to other warehouses that utilize a WCS to assign work tasks. The traditional workflow 100 is inefficient because it does not account for any downtime that the on-site operator may have or different proficiency levels. For example, each on-site operator will naturally have different strengths and weaknesses that are not taken into account when work tasks are assigned. Some on-site operators may be more proficient in handling freight in tight confines while others may be more proficient in handing irregularly shaped freight. Therefore, a need exists for a more efficient teleoperations system that makes more efficient use of teleoperators to help streamline warehouse operations.

Further, teleoperators frequently face significant challenges in maintaining contextual awareness, which hampers their ability to navigate within a warehouse. Additionally, they have restricted visibility of material labels once they are on the forks and encounter difficulties in accessing conventional location identifiers on racks or ceilings.

The present invention mitigates these challenges by providing teleoperators with real-time feedback on their current location, detailed information on materials available nearby, access to camera feeds for identifying materials in transit, and the ability to determine their location based on the vehicle's position. All these functionalities are seamlessly integrated into the same interface used to control the vehicle.

### SUMMARY

The present invention provides a teleoperations system that assigns move assignments to specific vehicles instead of directly to different teleoperators. Instead of operating a specific vehicle for an entire day, the teleoperator instead selects (or is assigned) move assignments and is connected to the vehicle associated with the move assignment. The teleoperator then performs the move assignment for that particular vehicle and then selects (or is assigned) the next move assignment. The next assignment may be associated with the same vehicle or an entirely different vehicle. This allows warehouse operations to be more efficient because even complex move assignments can be broken down into a plurality of work tasks and each work task can be carried out by a free teleoperator or the teleoperator best currently suited to perform any specific work task.

Further, the present invention provides a drive fulfillment system providing remote operators with real-time feedback on their current location, detailed information on materials available nearby, access to camera feeds for identifying materials in transit, and the ability to determine their location based on the vehicle's position. All these functionalities are seamlessly integrated into the same interface used to control the vehicle.

### BRIEF DESCRIPTION OF THE DRAWINGS

FIG. 1 depicts a traditional on-site operator workflow used in warehouse environments.

FIG. 2 a system diagram of the teleoperations system according to an embodiment of the invention.

FIG. 3 depicts a teleoperations workflow utilized by the teleoperations system showing how work tasks are assigned to vehicles and teleoperators according to an embodiment of the invention.

FIG. 4 depicts the communication workflow between a vehicle and the user interface during teleoperations according to an embodiment of the invention.

FIG. 5 depicts an example screen of the Drive Plus UI during pick-up according to an embodiment of the invention.

FIG. 6 depicts an example screen of the Drive Plus UI during a drop-off according to an embodiment of the invention.

FIG. 7 depicts a flowchart showing the steps utilized to perform a pick-up or drop-off according to an embodiment of the invention.

FIG. 8 depicts a flowchart showing the steps utilized to perform an orient to assignment operation according to an embodiment of the invention.

FIG. 9 depicts a flowchart showing the steps utilized to perform a check destination operation according to an embodiment of the invention.

FIG. 10 depicts a flowchart showing the steps utilized to perform label scanning according to an embodiment of the invention.

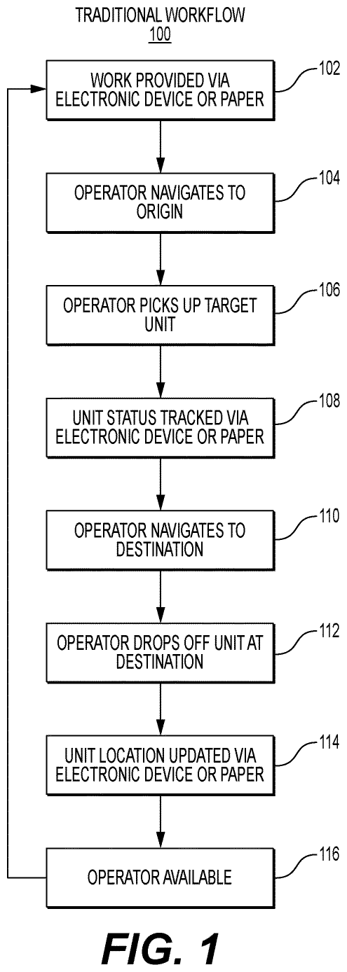

In one or more implementations, not all of the depicted components in each figure may be required, and one or more implementations may include additional components not shown in a figure. Variations in the arrangement and type of the components may be made without departing from the scope of the subject disclosure. Additional components, different components, or fewer components may be utilized within the scope of the subject disclosure.

### DETAILED DESCRIPTION

The detailed description set forth below is intended as a description of various implementations and is not intended to represent the only implementations in which the subject technology may be practiced. As those skilled in the art would realize, the described implementations may be modified in various different ways, all without departing from the scope of the present disclosure. Accordingly, the drawings and description are to be regarded as illustrative in nature and not restrictive.

The embodiments disclosed herein are for the purpose of providing a description of the present subject matter, and it is understood that the subject matter may be embodied in various other forms and combinations not shown in detail. Therefore, specific embodiments and features disclosed herein are not to be interpreted as limiting the subject matter as defined in the accompanying claims.

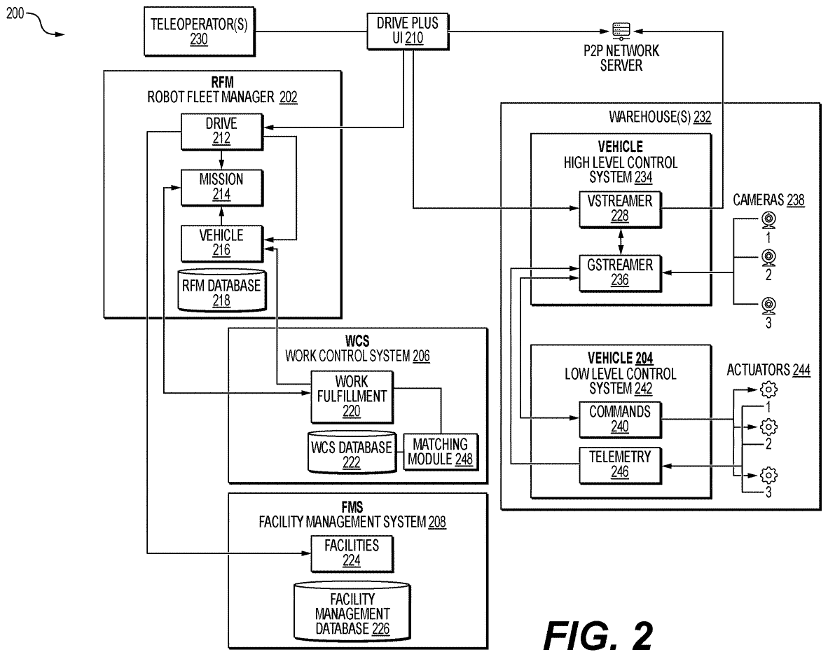

FIG. 2 depicts a system diagram of teleoperations system 200 according to an embodiment of the invention. Teleoperations system 200 comprises robot fleet manager (RFM) 202, vehicle(s) 204, work control system (WCS) 206, global facility management system (FMS) 208, and Drive Plus user interface (UI) 210. Teleoperator(s) 230 can utilize Drive Plus UI 210 to control any vehicle 204 that is coupled to teleoperations system 200 at one or more warehouse(s) 232. Each vehicle 204 may be a fully autonomous vehicle capable of free navigation, navigation along a predetermined path, remote control enabled for teleoperations, and/or locally controllable by a user (e.g., by manually operating the vehicle 204).

Each vehicle 204 comprises a high level control system 234 including VStreamer 228, GStreamer 236, and cameras or sensors 238. Cameras or sensors 238 supply video and sensor information to VStreamer 228, which is then transmitted to Drive Plus UI 210 for display to teleoperator 230. Drive Plus UI 210 provides the necessary information to teleoperator 230 to perform each assigned work task or move assignment.

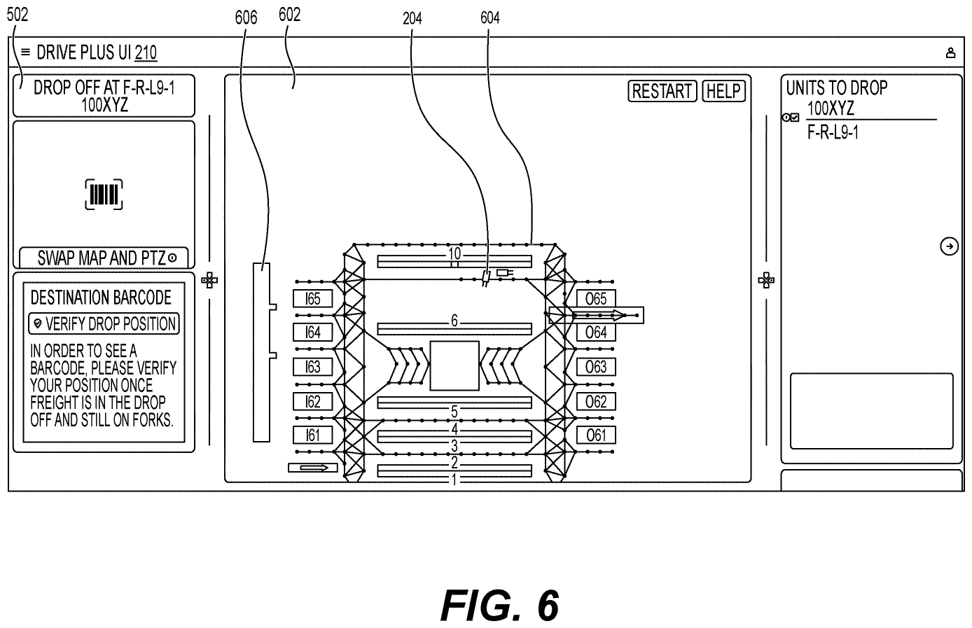

Each vehicle 204 further comprises a plurality of sensors or cameras for obstacle detection, navigation, environmental awareness, safety, etc. One or more video feeds and current vehicle information is gathered by VStreamer 228 and transmitted to Drive Plus UI 210 for display to teleoperator 230. Drive Plus UI 210 provides a top-down facility map 602 as best depicted in FIG. 6. Map 602 depicts a current real-time location of vehicle 204 being controlled by teleoperator 230 as well as any other vehicles 204 that may be present on map 602 (e.g., autonomous or controlled by other teleoperators 230). Map 602 may also display boundaries 604 or fixed obstacles 606.

GStreamer 236 receives control information from teleoperators 230 and translates the control information into vehicle operation commands 240 in low level control system 242. The vehicle operation commands 240 are used to control various operations associated with vehicle 204 such as travel direction, turning commands, forklift commands, etc. using actuators 244. GStreamer 236 may also collect telemetry data 246 to provide real-time feedback to teleoperator 230.

RFM 202 generally monitors the locations and status of vehicles 204 in each warehouse 232 and handles navigation and control of any autonomous vehicles 204. Drive module 212 determines which vehicles 204 are available to teleoperators 230 and provides vehicle-type specific configurations for Drive Plus UI 210. Mission module 214 assigns work tasks to each vehicle 104 and determines a route and instructions for each path. For example, mission module 214 may assign a work task to a vehicle 204 specifying a pick-up location, a drop-off location, as well as a path to follow (with waypoints). Vehicle module 216 monitors a status of each vehicle 204 such as battery or gas level, sensor status, mileage, etc. RFM database 218 can be used to store any data collected by modules 212-216 for long term storage.

WCS 206 coordinates all work tasks and other operations carried out by vehicles 204 under the control of teleoperators 230. For example, work fulfillment module 220 can calculate new work tasks as needed for vehicles 204 or calculate the number of teleoperators 230 needed based on calculated tasks for the day or week. WCS database 222 may store the calculated work tasks produced by WCS 206 for access by mission module 214.

RFM 202 also maintains a profile for each teleoperator 230 in RFM database 218 including certifications (e.g., forklift certified), training level, task ratings, etc. As teleoperator 230 performs work tasks, data is collected by RFM 202 related to the performance of different tasks to ascertain the task ratings. For example, RFM 202 may determine that a particular teleoperator 230 is more efficient at handling certain types of freight or has a higher success rate. The information stored in the profile for each teleoperator is used by drive module 212 to match available teleoperators 230 with the work tasks assigned to each vehicle 204. This ensures that each work task for each vehicle 204 is assigned to the most qualified teleoperator 230 available at any time. This performance data collected for each teleoperator 230 can also be used to provide rewards or incentives for accepting difficult work tasks or meeting certain performance metrics (e.g., improved efficiency 10% in a month, did not cause any freight damage, etc.).

Work tasks may be classified as autonomous compatible, teleoperator compatible, and/or manual. Only work tasks classified as teleoperator compatible are assigned to teleoperators 230. Autonomous compatible work tasks are available to be assigned to autonomous vehicles 204. Manual-only work tasks are generally reserved for difficult tasks (e.g., movement of expensive or delicate freight). Work tasks may also be assigned and reassigned to different classifications as needed. For example, if certain work tasks assigned to autonomous vehicles are regularly not completed, they may be assigned as teleoperator or manual tasks only in the future.

Work tasks may also be classified according to vehicle type. Each vehicle 204 may have different capabilities or classifications. For example, a first vehicle type 204 may be a forklift rated for a certain weight limit. Work tasks related to freight above the weight limit would not be assigned to the first vehicle type 204.

The classification of work tasks may also be utilized to provide different service levels to customers. For example, a customer may elect to only have work tasks be manually performed or performed by teleoperators. Any work tasks associated with the customer, or their freight, may then be limited to certain classifications.

In some embodiments, WCS 206 may split work tasks into a plurality of subtasks. As an example, a work task related to a pick-up and drop-off of freight may be split into three separate subtasks (a pick-up task, a conveyance task, and a drop-off task). The pick-up task and drop-off task may be classified as teleoperator or manual compatible whereas the conveyance task may be assigned any classification. The subtasks can be assigned to a vehicle 204 and be performed by one or more different teleoperators 230. By splitting certain work tasks into subtasks, the efficiency of teleoperations system 200 can be increased even further by ensuring work tasks and subtasks are assigned in the most efficient way possible.

FMS 208 is coupled to RFM 202 operating at each warehouse 232 to allow for real-time location mapping of vehicles 204 across different warehouses 232. Facilities module 224 allows a supervisor to monitor multiple different warehouses 232 from a single location. FMS 208 also allows engineers to modify facility layouts including location boundaries for each warehouse 232. Data gathered from each RFM 202 can be stored in facility management database 226, allowing for system-wide analysis of the data by a supervisor.

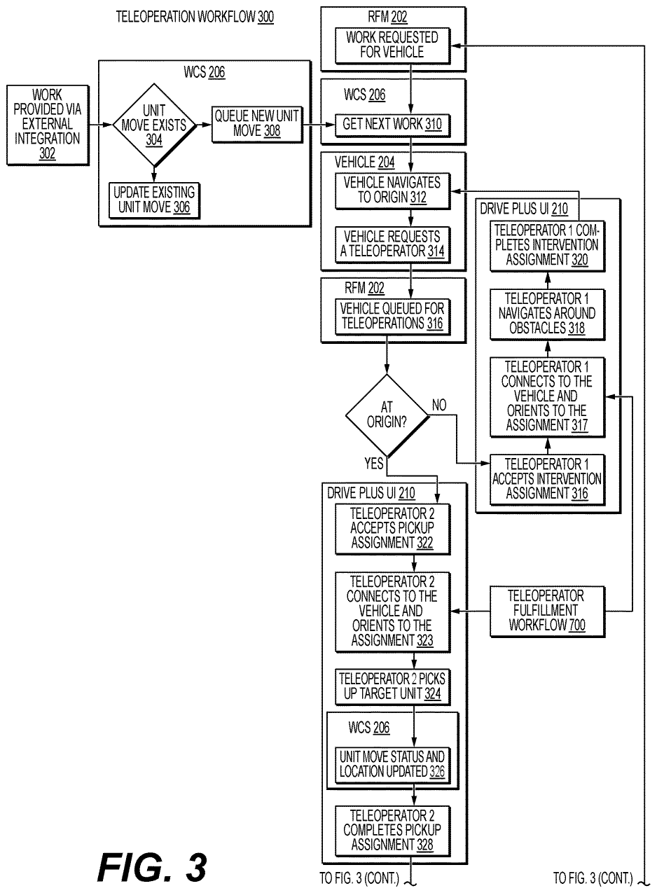

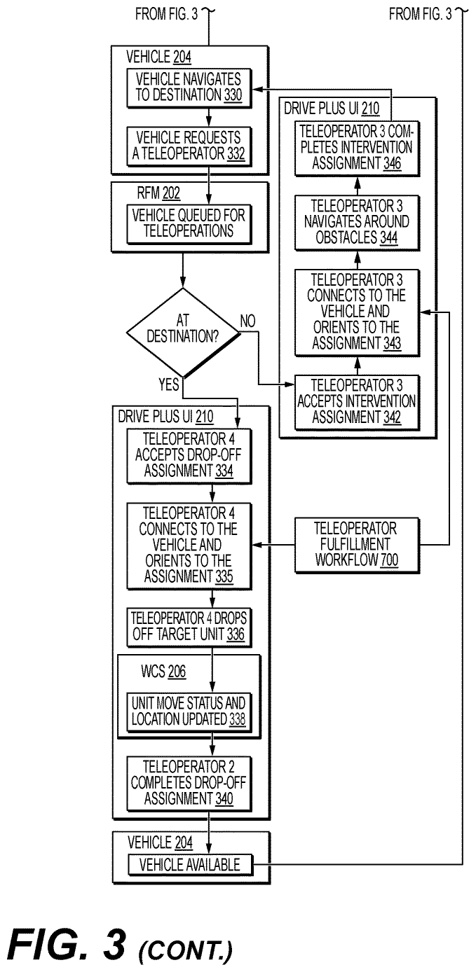

FIG. 3 depicts a teleoperations workflow 300 showing how work tasks are assigned to vehicles and teleoperators by teleoperations system 200. WCS 206 receives a plurality of data that is utilized to calculate work tasks in step 302. The data may include manifest data, shipping schedules, freight IDs, vehicle availability, teleoperator availability, etc. WCS 206 calculates work tasks in step 304 and stores them in WCS database 222 in step 306. The work tasks are queued for assignment in step 308.

WCS 206 determine the next work task to be performed in step 310 and assigns it to a vehicle 204 in step 312. As previously explained, RFM 202 monitors the status of all vehicles 204 and requests work from WCS 206 when a vehicle 204 is available for work tasks. After vehicle 204 is assigned a work task in step 312 and finishes any autonomous subtasks, the vehicle 204 requests a teleoperator 230 best suited for performing the assigned work task in step 314.

If the assigned vehicle 204 is not currently at the required origin for the work task, an intervention work task may be created by RFM 202 and assigned to a teleoperator 230 in step 316. The intervention work task allows for any corrections to be made (e.g., vehicles 204 are positioned incorrectly) without disturbing the overall workflow of teleoperations system 200. The teleoperator 230 is connected to the Drive Plus UI 210 of the vehicle 204 in step 317 upon acceptance of the work task and the teleoperator 230 navigates the vehicle 204 in step 317. The teleoperator 230 completes the intervention work task in step 320.

If the assigned vehicle 204 is at the required origin for the work task, the work task is assigned to a teleoperator 230 by drive module 212 in step 322. The teleoperator 230 picks up the target freight in step 324 and WCS 206 verifies that the work task has been completed in step 326. The teleoperator 230 is disconnected from vehicle 204 in step 328 after it is confirmed that the work task (pick up operation) is complete.

With the freight picked up, the vehicle 204 navigates to a destination in step 330. This conveyance may be accomplished by assigning a work task to a teleoperator 230 or instructing the vehicle 204 to autonomously navigate to the destination (if possible). When the vehicle 204 reaches the destination, it requests a teleoperator 230 to perform the next work task of dropping off the freight in step 332.

Drive module 212 assigns a teleoperator 230 to the drop-off work task in step 334. The assigned teleoperator 230 completes the drop-off work task in step 336 which is verified by WCS 206 in step 338. The teleoperator 230 is then disconnected from vehicle 204 in step 340 upon completion of the work task.

If the assigned vehicle 204 is not currently at the destination for the work task, an intervention work task may be created by RFM 202 and assigned to a teleoperator 230 in step 342. The intervention work task allows for any corrections to be made (e.g., vehicles 204 are positioned incorrectly) without disturbing the overall workflow of teleoperations system 200. The teleoperator 230 is connected to the Drive Plus UI 210 of the vehicle 204 in step 343 upon acceptance of the work task and the teleoperator 230 navigates the vehicle 204 in step 344. The teleoperator 230 completes the intervention work task in step 346.

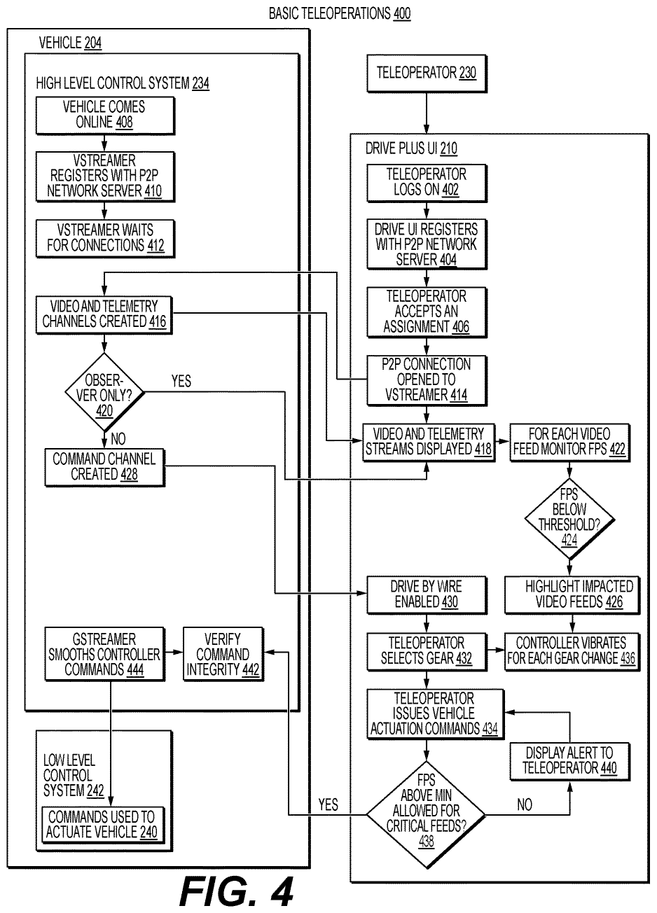

FIG. 4 depicts the teleoperations communications 400 between vehicle 204 and Drive Plus UI 210 during teleoperations by a teleoperator 230. First teleoperator 230 logs into the drive user interface in step 402 to begin a teleoperations session. Drive Plus UI 210 registers the teleoperator 230 with WCS 206 in step 404, allowing the teleoperator 230 be provided with work assignments. The teleoperator 230 can then select a particular work task from a plurality of assignments in step 406.

At each warehouse 232, the vehicles 204 come online (e.g., according to a predetermined schedule or as needed) in step 408 and register with Drive Plus UI 210 in step 410. Vehicles 204 must be registered with the RFM 202 prior to being assigned any work tasks. Generally, vehicles 204 remain in standby in step 412 awaiting a connection from a teleoperator 230.

After a teleoperator 230 accepts a work task in step 406, Drive Plus UI 210 utilizes VStreamer 228 to connect the teleoperator 230 to a vehicle 204 in step 414. The vehicle associated with the selected work task establishes video and telemetry channels with Drive Plus UI 210 in step 416. This allows teleoperator 230 to view video and other telemetry information received from the connected vehicle 204 in step 418. For example, the teleoperator 230 may view Drive Plus UI 210 using a tablet, workstation, or other device with a suitable display and input capabilities for controlling vehicle 204. For example, teleoperator 230 may utilize a custom controller or a video game controller to control the basic operations of a vehicle 204.

If the teleoperator 230 is only provided observer access by Drive Plus UI 210 as determined in step 420, only the video and telemetry streams are provided to the teleoperator 230 and control of the vehicle 204 is not allowed. For example, a teleoperator 230 may be a supervisor that can simultaneously view the telemetry and video data associated with a particular vehicle 204 controlled by another teleoperator 230. The supervisor can monitor the performance of the other teleoperator 230 during training or can help troubleshoot issues the other teleoperator may be having with a particular work task.

For each video and telemetry stream initiated by Drive Plus UI 210, the quality of the streams are monitored in step 422. If the frames per second (FPS) of a particular video stream fall below a predetermined or variable threshold as determined in step 424, they are brought to the attention of the RFM 202 in step 426 for troubleshooting. For example, RFM 202 may increase the bandwidth to a particular video feed, utilize a different streaming server, etc., in an attempt to increase the FPS of the video feed. If the FPS of a particular video feed cannot be remedied or increased, the RFM 202 may terminate that particular video feed and make the work task associated with the teleoperations session available to another teleoperator in step 406.

If the teleoperator 230 is not an observer as determined in step 420, a command channel is created in step 428 between the vehicle 204 and Drive Plus UI 210. The establishment of the command channel allows the teleoperator 230 to control the operation of vehicle 204 utilizing Drive Plus UI 210 in step 430. The teleoperator 230 can control any of the functions allowed by Drive Plus UI 210 such as gear selection 432 or control commands 434 (e.g., reverse, forward, forklift operations, etc). The Drive Plus UI 210 may provide the user feedback 436, such as haptic feedback or other displays, as an acknowledgement of each command issued.

Teleoperators 230 that are allowed to remotely control vehicles 204 using Drive Plus UI 210 must generally have a more stable and robust connection than observers. Drive Plus UI 210 monitors the FPS of operators in step 438 to ensure they remain above a second predetermined threshold (generally higher than that required for observers in step 424). If the FPS falls below the second predetermined threshold the teleoperator is notified in step 440 and remote operation of vehicle 204 may temporarily be suspended. If the FPS remains above the second predetermined threshold, the Drive Plus UI 210 sends the commands to vehicle 204 where they are verified in step 442 and smoothing may be applied in step 444.

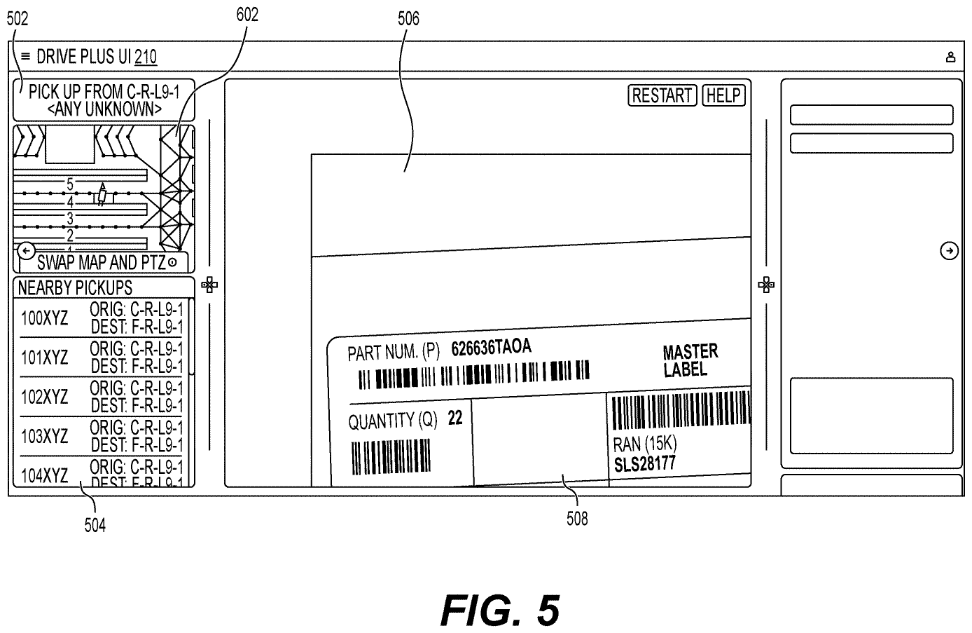

FIG. 5 depicts an example screen of Drive Plus UI 210 during a pick-up task or operation. A current task 502 may be displayed to teleoperator 230 along with map 602 and nearby pick-up locations 504. Map 602 displays the connected vehicle's 204 location and orientation, nearby warehouse locations, and indicators pointing to the target location associated with task 502. Each pick-up location 504 may display an associated ID, description, current warehouse address, and other information.

VStreamer 228 provides Drive Plus UI 210 with access to a front-facing camera on vehicle 204 in viewer 506, enabling teleoperator 230 to read or scan the label 508.

FIG. 6 depicts an example screen of the Drive Plus UI 210 during a drop-off task or operation. After the freight associated with label 508 is scanned and picked up, task 502 is updated as depicted in FIG. 6 to specify a drop-off location. Because teleoperator 230 must navigate vehicle 204 to a destination location, map 602 is enlarged on Drive Plus UI 210 as depicted. The teleoperator 230 uses map 602 to direct vehicle 204 to the specified drop-off location, after which the drop-off location is verified based on the vehicle's 204 location or a destination machine readable code is scanned to indicate the drop-off has been completed. Because the teleoperator 230 scans the label 508 at pick-up and verifies the drop-off location or scans the machine readable code at drop-off, the exact location of the vehicle 204 can be recorded at both locations since the real-time location of vehicle 204 is always known.

The scanning of label 508 and/or the destination machine readable code may be fully automated which removes the necessity of teleoperator 230 to interact with handling unit labels. Automating pick-ups after scanning label 508 eliminates the requirement for teleoperators 230 to orient themselves and identify the materials to be moved. Automating drop-offs negates the need for teleoperators 230 to navigate the vehicle 204 to a destination and to trigger drop-off.

Drive Plus UI 210 minimizes distractions for teleoperators 230 by eliminating the necessity for a secondary monitor. It also conserves bandwidth by removing the additional data required to synchronize a secondary application. Furthermore, it enhances the accuracy of inventory location tracking by ensuring teleoperators 230 record activities as they happen and by capturing drop-off addresses based on the vehicle's 204 actual spatial location, rather than relying on manually entered data.

Drive Plus UI 210 streamlines the teleoperator 230 experience by consolidating their tasks within a single interface, thereby reducing the need to switch from the vehicle control interface to a mouse and keyboard like in current systems.

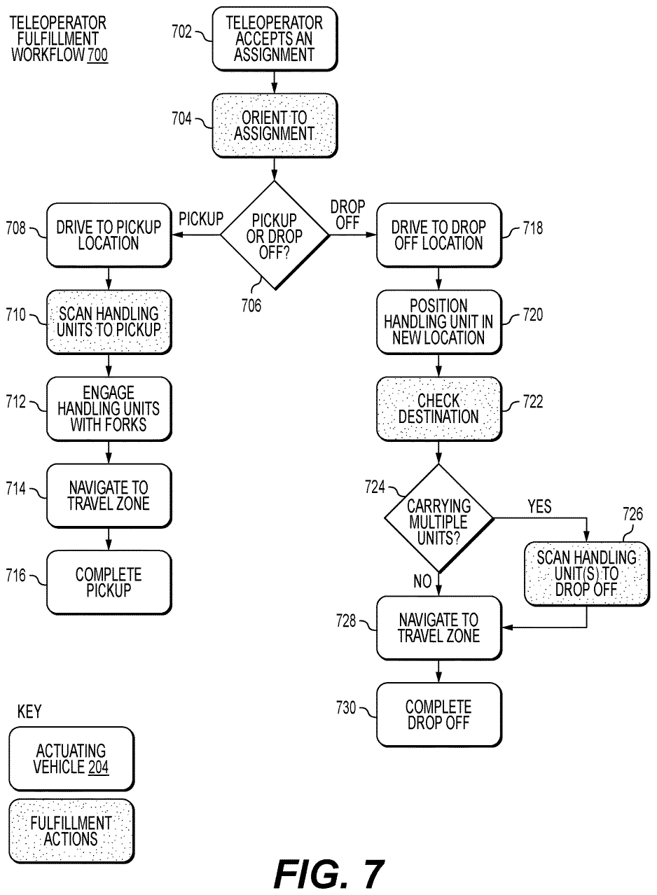

FIG. 7 depicts a flowchart for the teleoperator fulfillment workflow 700 showing the steps utilized to perform a pick-up or drop-off by teleoperator 230 using vehicle 204. First, teleoperator 230 accepts a task 502 which is displayed on Drive Plus UI 210 in step 702. Teleoperator 230 then orients the vehicle 204 to pick up or drop off in step 704. If the task 502 is a pick-up as determined in step 706, the teleoperator 230 drives to the specified pick-up location in step 708. The label 508 associated with the pick-up is scanned in step 710 using viewer 506 of Drive Plus UI 210. The teleoperator 230 engages the pick-up with forks of vehicle 204 in step 712 and navigates to a travel zone of local environment 232 in step 714. Once the travel zone is reached, Drive Plus UI 210 records that the pick-up has been completed in step 716.

After the vehicle 204 arrives at the destination, teleoperator 230 accepts a task 502 which is displayed on Drive Plus UI 210 in step 702. Teleoperator 230 then orients the vehicle 204 to drop off in step 704. The task 502 in Drive Plus UI 210 is updated to indicate the drop off location as depicted in FIG. 6. The teleoperator 230 drives to the drop off location in step 718 and positions the handling unit of vehicle 204 at the new location in step 720. The destination vicinity is checked by sensors of vehicle 204 in step 722 to ensure the drop off can be completed and the vehicle 204 location is cross-checked with the drop off location boundaries from FMS 208. If vehicle 204 is carrying multiple units to be dropped off as determined in step 724, the destination machine readable code at the first drop off location is scanned in step 726 and the vehicle 204 navigates to the travel zone in step 728 to complete any further drop-offs. Steps 702-728 are repeated by vehicle 204 until the final destination machine readable code is scanned in step 730 which indicates that the drop-off task 502 has been successfully completed.

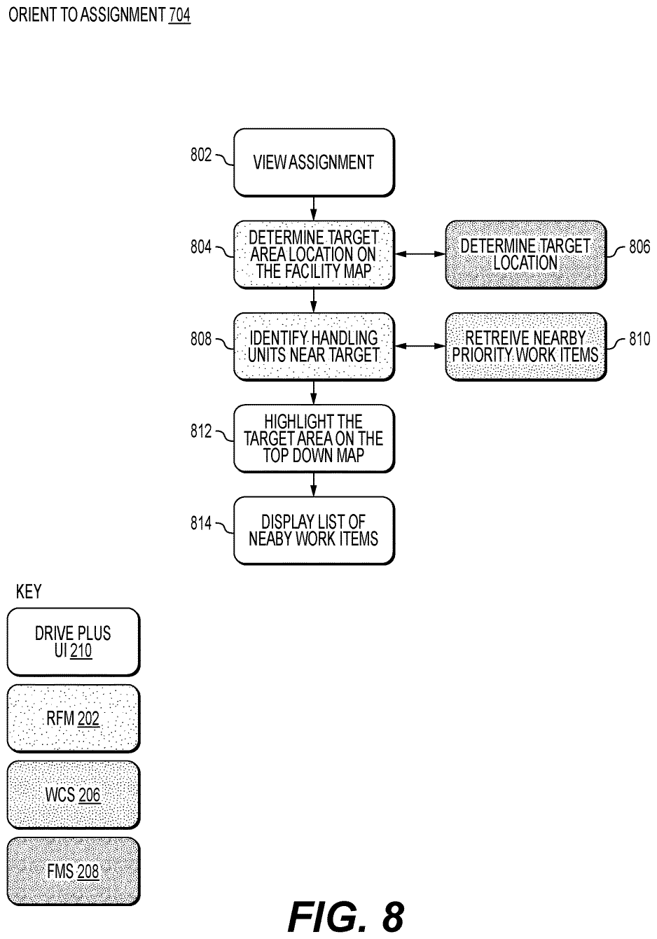

FIG. 8 depicts a flowchart showing the steps utilized to perform orient to assignment step 704. The teleoperator 230 views the assignment in step 802. The target location for the task 502 is retrieved in step 806 and displayed on the facility map 602 in step 804. Handling units in the vicinity of task 502 are also displayed on map 602 on Drive Plus UI 210 and are retrieved (step 810) and displayed in step 808. The target area for the pick-up is highlighted on map 602 in step 812 and the list of nearby work items may be updated in step 814.

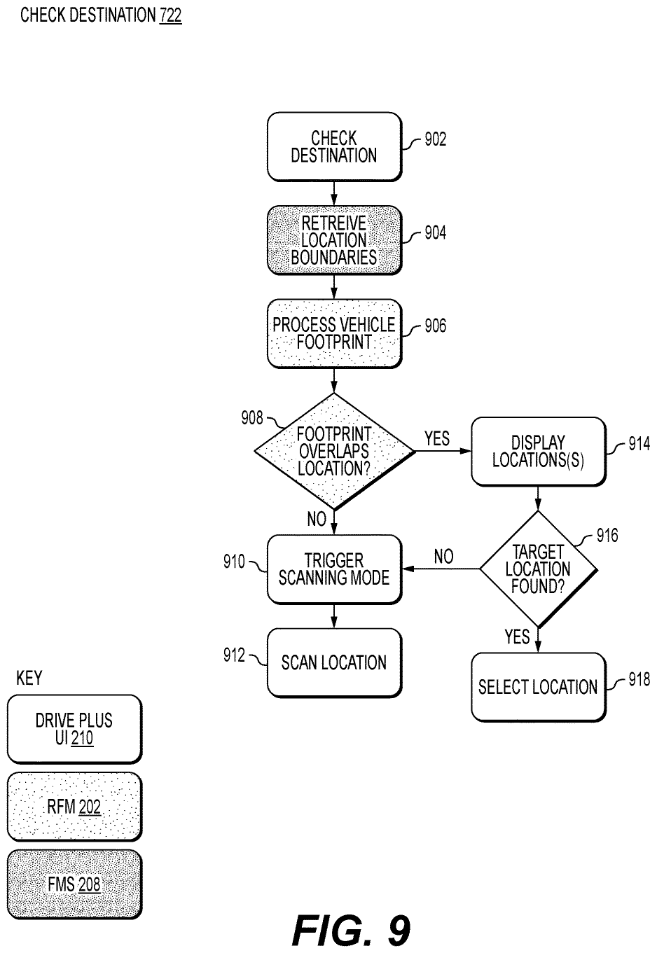

FIG. 9 depicts a flowchart showing the steps utilized to perform check destination step 722. A check of the destination is performed in step 902. The location boundaries of the destination are retrieved in step 904 and are compared to the footprint of vehicle 204 in step 906. If the footprint location overlaps with the destination location as decided in step 908, Drive Plus UI 210 displays overlapping locations to teleoperator 230 to select from in step 914. If the target location is found as determined in step 916, the teleoperator 230 can select the location in step 918. If the footprint location does not overlap as determined in step 908 or the target location is not found in step 916, scanning mode of the Drive Plus UI 210 is started. This enables scanning of the destination machine-readable code by teleoperator 230 in step 910 or automatically by vehicle 204 in step 912.

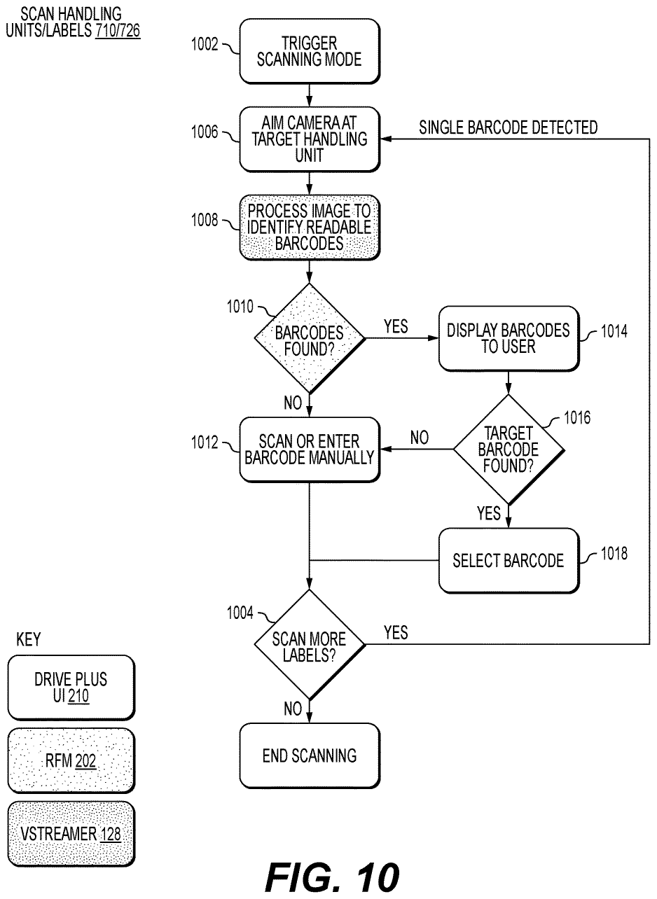

FIG. 10 depicts a flowchart showing the steps utilized to perform scanning step 710 or 726. To scan a label 508 or destination machine-readable code, the teleoperator 230 triggers the scanning mode in step 1002 and directs the camera of vehicle 204 at label 508 using viewer 506 in step 1006. The captured image is processed in step 1008 to identify all machine-readable codes or labels. If only a single label or barcode 508 is detected, it is scanned, and the system is ready to scan other objects. If labels or barcodes 508 are detected in the image as determined in step 1010, the multiple barcodes are displayed to teleoperator 230 in step 1014. If the correct label 508 is in the list as determined in step 1016, teleoperator 230 can select the barcode in step 1018. If the correct label 508 is not in the list, the teleoperator 230 can manually scan label 508 or enter the information manually in step 1012. The teleoperator 230 can then scan more labels or barcodes in step 1004.

While the present invention has been described with respect to what is presently considered to be the preferred embodiments, it is to be understood that the invention is not limited to the disclosed embodiments. To the contrary, the invention is intended to cover various modifications and equivalent arrangements included within the spirit and scope of the appended claims. The scope of the following claims is to be accorded the broadest interpretation so as to encompass all such modifications and equivalent structures and functions.

1. A teleoperations system comprising:
a plurality of vehicles,
wherein each vehicle can be locally operated or remotely operated;
a work control system (WCS) for determining a plurality of work tasks for completion at a remote facility,
wherein each work task of the plurality of work tasks is assigned to a specific vehicle from the plurality of vehicles;
a driver user interface (UI) comprising:
a work task selection module configured to display a work task selection screen,
wherein a first teleoperator selects a first work task from the plurality of work tasks; and
a vehicle control module for establishing a remote connection with a first vehicle associated with the first work task,
wherein the vehicle control module displays one or more video feeds received from the first vehicle; and
wherein the vehicle control module transmits vehicle actuation commands received from the first teleoperator to the first vehicle to perform the first work task; and
a work fulfillment module for monitoring the first teleoperator during the remote connection,
wherein the work fulfillment module terminates the remote connection upon determining the first work task is completed.

2. The teleoperations system of claim 1, further comprising:
a matching module for automatically assigning each work task of the plurality of work tasks to a teleoperator from the plurality of teleoperators based on required skills for each work task.

3. The teleoperations system of claim 1, wherein the predetermined skills include an overall skill level or a certification level.

4. The teleoperations system of claim 1, wherein the first teleoperator is assigned a second work task for a second vehicle after the first work task is completed.

5. The teleoperations system of claim 1, wherein the plurality of work tasks are assigned a category from a plurality of categories based on actions performed during the work task.

6. The teleoperations system of claim 5, wherein the categories include a pick-up operation, a drop-off operation, and a conveyance operation.

7. The teleoperations system of claim 1, wherein the driver UI further comprises:
an observation module to allow a second teleoperator to establish a remote connection with the first vehicle,
wherein the observation module displays the one or more video feeds received from the first vehicle to the second operator, and
wherein the second teleoperator is restricted from transmitting vehicle actuation commands to the first vehicle.

8. The teleoperations system of claim 1, further comprising:
a telemetry monitoring module for monitoring a stability of the remote connection,
wherein the remote connection is terminated if a telemetry parameter falls below a predetermined threshold.

9. The teleoperations system of claim 8, wherein the telemetry parameter is frames per second (FPS) of the one ore more received video feeds.

10. The teleoperations system of claim 8, wherein the first work task is assigned to a second teleoperator if the remote connection is terminated by the telemetry monitoring module.

11. A teleoperations system comprising:
a plurality of vehicles,
wherein each vehicle can be locally operated or remotely operated;
a work control system (WCS) for determining a plurality of work tasks for completion at a remote facility,
wherein each work task of the plurality of work tasks is assigned to a specific vehicle from the plurality of vehicles, and
wherein each work task is assigned to a specific teleoperator from a plurality of teleoperators;
a driver user interface (UI) comprising:
a vehicle control module for establishing a remote connection for each work task between the assigned specific vehicle and the assigned specific teleoperator,
wherein the vehicle control module displays one or more video feeds received from the assigned specific vehicle to the assigned specific operator; and
wherein the vehicle control module transmits vehicle actuation commands received from the assigned specific operator to the assigned specific vehicle; and
a work fulfillment module for monitoring the remote connection established for each work task,
wherein the work fulfillment module terminates the remote connection established for each work task as each work task is completed.

12. A teleoperator user interface for performing work tasks comprising:
a current task display for displaying a current task to a teleoperator;
a facility map for displaying a real-time vehicle position of a vehicle controlled by the teleoperator,
wherein the facility map includes icons representing freight and obstacles in a vicinity of the vehicle;
a label display for displaying a camera feed received from the vehicle controlled by the teleoperator,
wherein the teleoperator can adjust the camera feed using vehicle actuation commands,
wherein any machine-readable codes or text contained in the label display are automatically decoded by a scanning module,
wherein the current task display is updated after decoding a machine-readable code associated with the current task.

13. The teleoperator user interface of claim 12, wherein the teleoperator can enable or disable the facility map or the label display.

14. The teleoperator user interface of claim 12, further comprising:
a notification panel, wherein the notification panel displays information related to the freight and the obstacles in the vicinity of the vehicle.

15. The teleoperations user interface of claim 12, wherein the current task display is updated as each step of the current task is completed by the teleoperator.
